(19) United States
(12) Patent Application Publication
(10) Pub. No.: US 2020/0036060 A1
(43) Pub. Date: Jan. 30, 2020

(54) Method for Processing Waste Lead-Acid Batteries

(71) Applicants: Yuan-Tsang Chang, Taichung City (TW); Yung-Sung Chen, Chiayi City (TW)

(72) Inventor: Yung-Sung Chen, Chiayi City (TW)

(21) Appl. No.: 16/047,175

(22) Filed: Jul. 27, 2018

(51) Int. Cl. H01M 10/54; B02C 21/00; B02C 23/14; H01M 10/06

(52) U.S. Cl. CPC H01M 10/54; B02C 21/00; B02C 2201/06; H01M 10/06; B02C 23/14

(57) ABSTRACT

A method of processing waste lead-acid batteries includes a crushing step, a sorting step, a plastic fragment treating step, and a plastic bit recycling step. Through the four steps, waste lead-acid batteries are turned into lead fragments, high-density plastic fragments, and plastic bits, which are recyclable as reusable materials, respectively. Moreover, waste liquid and waste gas in the waste lead-acid batteries are sent to a waste liquid treating equipment and a waste gas treating equipment, respectively, for further appropriate treatment. Therefore, the method may appropriately recycle useful materials of the waste lead-acid batteries and prevent the waste liquid and the waste gas from polluting the environment.

### BACKGROUND OF THE INVENTION

### 1. Field of the Invention

The present invention relates to a method for processing waste lead-acid batteries, and more particularly to a method that may prevent environmental pollution and hygienic problems, and may improve rates of recycling and reuse.

### 2. Description of Related Art

Despite great progress in industry and technology, pollution out of industrial waste has gradually caused harm to people's health, and that raises people's environmental consciousness. In addition, the fact that natural resources are becoming depleted promotes the development of circular economy. As a result, techniques for recycling and reusing a variety of wastes have rapidly developed.

In the modern society, people highly depend on private vehicles for transportation. Most of the private vehicles such as an automobile or a motorcycle each have a lead-acid battery to power an engine of the private transport. Although the lead-acid batteries are used widespreadly, the lead-acid batteries which are damaged or discarded not only occupy a lot of space, but also severely pollute the environment since waste liquid of the lead-acid batteries may easily leak out.

To sum up, people should process the waste lead-acid batteries properly, and thus the following work is needed: sorting and recycling reusable materials, and taking an appropriate treatment on the waste liquid to avoid polluting the environment.

### SUMMARY OF THE INVENTION

The main objective of the present invention is to provide a method for processing waste lead-acid batteries, in order to sort and recycle reusable materials, and take an appropriate treatment of the waste liquid to avoid polluting the environment.

The method of processing waste lead-acid batteries includes a crushing step, a sorting step, a plastic fragment treating step, and a plastic bit recycling step. In the crushing step, a waste lead-acid battery is crushed into multiple fragments, waste liquid, and waste gas. In the sorting step, the multiple fragments are separated into multiple lead fragments and multiple plastic fragments by a density difference between lead and plastics. In the plastic fragment treating step, the multiple plastic fragments are separated into multiple high-density plastic fragments and multiple low-density plastic fragments by a density difference between two kinds of plastics. In the plastic bit recycling step, the multiple low-density plastic fragments are dewatered and smashed into plastic bits.

Through the four steps, waste lead-acid batteries are turned into lead fragments, high-density plastic fragments, and plastic bits, which are recyclable as reusable materials, respectively. Moreover, waste liquid and waste gas in the waste lead-acid batteries are sent to a waste liquid treating equipment and a waste gas treating equipment, respectively, for further appropriate treatment. Therefore, the method may appropriately recycle useful materials of the waste lead-acid batteries and prevent the waste liquid and the waste gas from polluting the environment.

Other objectives, advantages and novel features of the invention will become more apparent from the following detailed description when taken in conjunction with the accompanying drawings.

### BRIEF DESCRIPTION OF THE DRAWINGS

FIG. 1 is an operational block diagram of a method for processing waste lead-acid batteries in accordance with the present invention;

FIG. 2 is an operational chart of the method in FIG. 1;

FIG. 3 is a flow chart of the method in FIG. 1; and

FIG. 4 is a block diagram to show products of a waste lead-acid battery processed by the method in FIG. 1.

### DETAILED DESCRIPTION OF THE PREFERRED EMBODIMENT

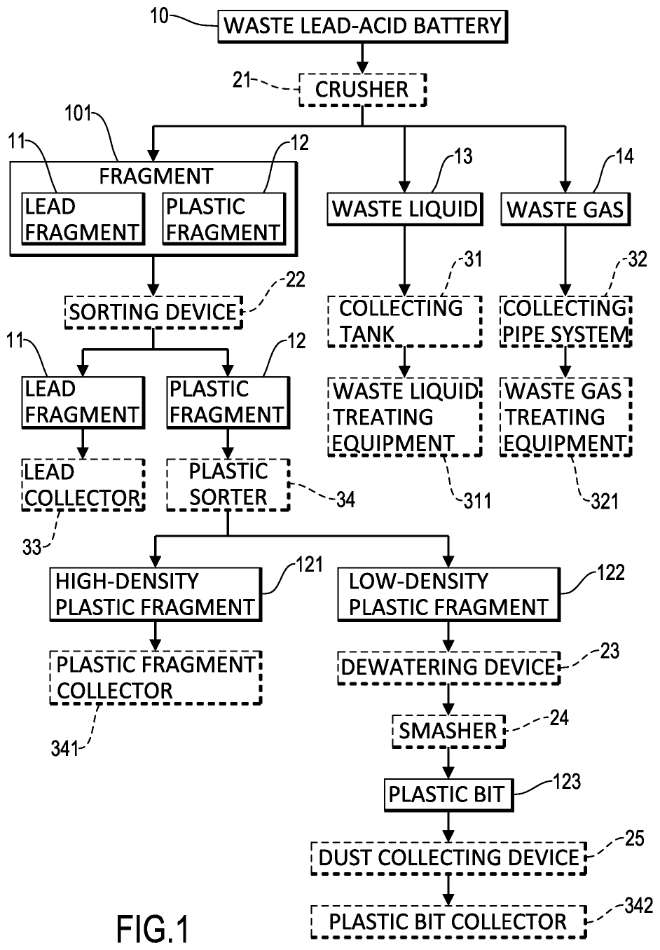

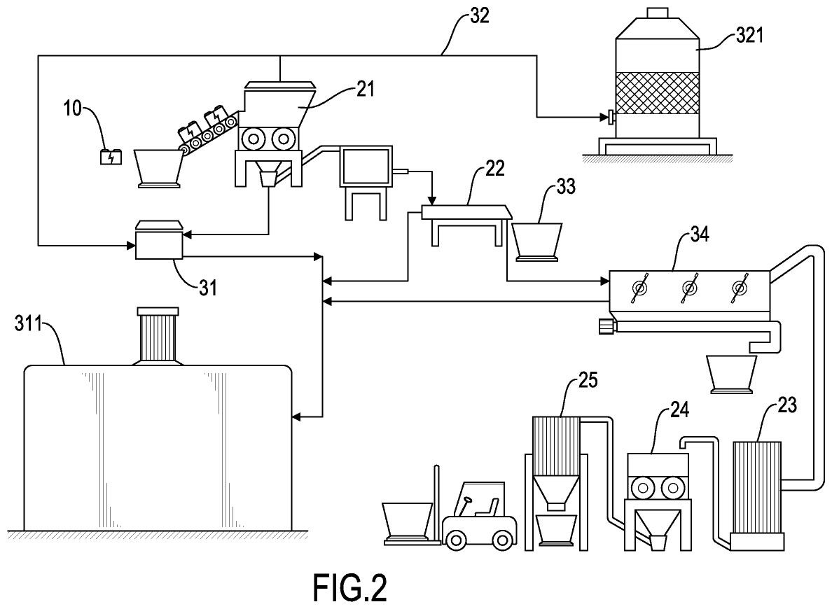

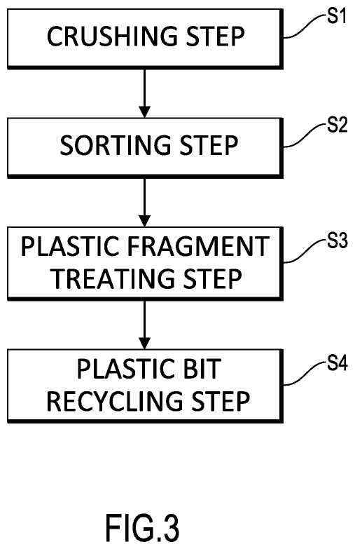

With reference to FIGS. 1 to 3, a method for processing waste lead-acid batteries in accordance with the present invention is applied with multiple processing equipments and multiple waste treating equipments.

The multiple processing equipments comprise a crusher 21, a sorting device 22, a dewatering device 23, a smasher 24, and a dust collecting device 25. The multiple waste treating equipments comprise a collecting tank 31, a waste liquid treating equipment 311, a collecting pipe system 32 comprising multiple pipes, a waste gas treating equipment 321, a lead collector 33, a plastic sorter 34, a plastic fragment collector 341, and a plastic bit collector 342.

With the multiple processing equipments and the multiple waste treating equipments mentioned above, the method for processing waste lead-acid batteries in accordance with the present invention comprises the following steps:

S1. A crushing step: putting a waste lead-acid battery 10 into the crusher 21. The waste lead-acid battery 10 will be crushed by the crusher 21 and is turned into multiple fragments 101, waste liquid 13, and waste gas 14. The multiple fragments 101 comprise multiple lead fragments 11 and multiple plastic fragments 12, and the multiple fragments 101 are further delivered to the sorting device 22. The waste liquid 13 is drained to the collecting tank 31, and flows to the waste liquid treating equipment 311. The waste gas 14 is transferred to the waste gas treating equipment 321 by the collecting pipe system 32.

S2. A sorting step: because plastics and lead have different densities, the sorting device 22 will sort out the multiple plastic fragments 12 from the multiple lead fragments 11. After separated, the multiple lead fragments 11 will be sent to the lead collector 33, and the multiple plastic fragments 12 will be sent to the plastic sorter 34 for further processing. Recycling of lead is done in the sorting step.

S3. A plastic fragment treating step: the multiple plastic fragments 12 are sorted into multiple high-density plastic fragments 121 and multiple low-density plastic fragments 122 by density difference. Taking advantage of the difference in density, the plastic sorter 34 is enabled to separate the multiple plastic fragments 121, 122 of two different densities. The multiple high-density plastic fragments 121 will be sent to the plastic fragment collector 341, and recycling of high-density plastic is therefore done. On the other hand, the multiple low-density plastic fragments 122 will undergo a further step.

S4. A plastic bit recycling step: with the dewatering device 23 and the smasher 24, dewater and smash the multiple low-density plastic fragments 122 in series, and then the multiple low-density plastic fragments 122 will become multiple plastic bits 123. Putting the multiple plastic bits 123 into the plastic bit collector 342 by applying the dust collecting device 25, and recycling of the plastic bits 123 is finished.

Additionally, in the steps of S2 and S3, there is still waste liquid 13 left in the sorting device 22 and the plastic sorter 34 during the processes of separating the multiple lead fragments 11, the multiple high-density plastic fragments 121, and the multiple low-density plastic fragments 122. The waste liquid 13 in the sorting device 22 and the plastic sorter 34 may be drained to interflow with the waste liquid 13 in the collecting tank 31, and become confluent with the waste liquid 13 in the waste liquid treating equipment 311 for further treatment.

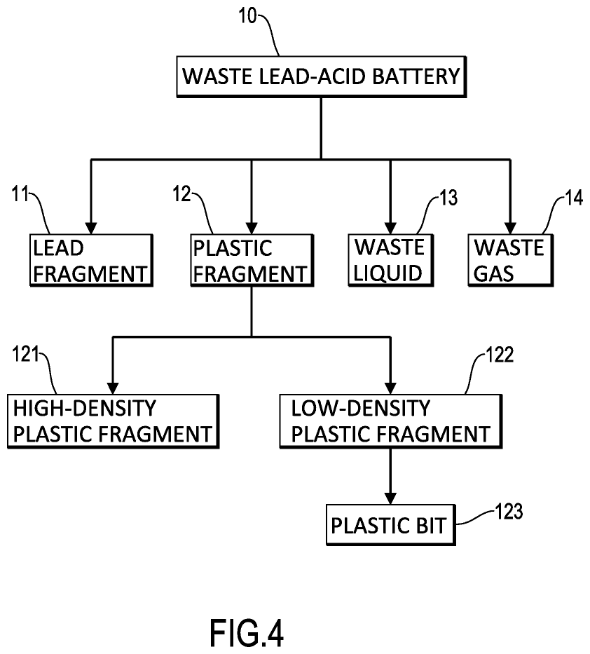

With reference to FIG. 4, multiple waste lead-acid batteries 10 are turned into lead fragments 11, high-density plastic fragments 121, and plastic bits 123, which are respectively recycled as reusable materials through the steps S1 to S4. Moreover, the waste liquid 13 and waste gas 14 in the waste lead-acid batteries 10 are sent to the waste liquid treating equipment 311 and the waste gas treating equipment 321, respectively, for further appropriate treatment. With the aforementioned technical characteristics, the method for processing waste lead-acid batteries solves the problem that waste lead-acid batteries 10 occupy a lot of space and inner waste liquid thereof severely pollutes the environment.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of processing waste lead-acid batteries, the method comprising steps as follows:
a crushing step comprising crushing a waste lead-acid battery into multiple fragments, waste liquid, and waste gas;
a sorting step comprising separating the multiple fragments into multiple lead fragments and multiple plastic fragments by a density difference between lead and plastics;
a plastic fragment treating step comprising separating the multiple plastic fragments into multiple high-density plastic fragments and multiple low-density plastic fragments by a density difference between two kinds of plastics; and
a plastic bit recycling step comprising dewatering and smashing the multiple low-density plastic fragments to turn the multiple low-density plastic fragments into plastic bits.

2. The method of processing waste lead-acid batteries as claimed in claim 1, wherein waste liquid is also produced in the sorting step and the plastic fragment treating step, and the waste liquid is drained to a waste liquid treating equipment.

3. The method of processing waste lead-acid batteries as claimed in claim 1, wherein in the crushing step, the waste gas is transferred into a waste gas treating equipment.

4. The method of processing waste lead-acid batteries as claimed in claim 2, wherein in the crushing step, the waste gas is transferred into a waste gas treating equipment.

5. The method of processing waste lead-acid batteries as claimed in claim 1, wherein in the crushing step, the waste lead-acid battery is crushed by a crusher.

6. The method of processing waste lead-acid batteries as claimed in claim 2, wherein in the crushing step, the waste lead-acid battery is crushed by a crusher.

7. The method of processing waste lead-acid batteries as claimed in claim 3, wherein in the crushing step, the waste lead-acid battery is crushed by a crusher.

8. The method of processing waste lead-acid batteries as claimed in claim 4, wherein in the crushing step, the waste lead-acid battery is crushed by a crusher.

9. The method of processing waste lead-acid batteries as claimed in claim 5, wherein in the sorting step, the multiple fragments are separated into the multiple lead fragments and the multiple plastic fragments by a sorting device, and the multiple lead fragments are collected to a lead collector.

10. The method of processing waste lead-acid batteries as claimed in claim 6, wherein in the sorting step, the multiple fragments are separated into the multiple lead fragments and the multiple plastic fragments by a sorting device, and the multiple lead fragments are collected to a lead collector.

11. The method of processing waste lead-acid batteries as claimed in claim 7, wherein in the sorting step, the multiple fragments are separated into the multiple lead fragments and the multiple plastic fragments by a sorting device, and the multiple lead fragments are collected to a lead collector.

12. The method of processing waste lead-acid batteries as claimed in claim 8, wherein in the sorting step, the multiple fragments are separated into the multiple lead fragments and the multiple plastic fragments by a sorting device, and the multiple lead fragments are collected to a lead collector.

13. The method of processing waste lead-acid batteries as claimed in claim 9, wherein in the plastic fragment treating step, the multiple plastic fragments are separated into the multiple high-density plastic fragments and the multiple low-density plastic fragments by a plastic sorter, and the multiple high-density plastic fragments are collected to a plastic fragment collector.

14. The method of processing waste lead-acid batteries as claimed in claim 10, wherein in the plastic fragment treating step, the multiple plastic fragments are separated into the multiple high-density plastic fragments and the multiple low-density plastic fragments by a plastic sorter, and the multiple high-density plastic fragments are collected to a plastic fragment collector.

15. The method of processing waste lead-acid batteries as claimed in claim 11, wherein in the plastic fragment treating step, the multiple plastic fragments are separated into the multiple high-density plastic fragments and the multiple low-density plastic fragments by a plastic sorter, and the multiple high-density plastic fragments are collected to a plastic fragment collector.

16. The method of processing waste lead-acid batteries as claimed in claim 12, wherein in the plastic fragment treating step, the multiple plastic fragments are separated into the multiple high-density plastic fragments and the multiple low-density plastic fragments by a plastic sorter, and the multiple high-density plastic fragments are collected to a plastic fragment collector.

17. The method of processing waste lead-acid batteries as claimed in claim 13, wherein in the plastic bit recycling step, the multiple low-density fragments are dewatered by a dewatering device and smashed by a smasher to become the multiple plastic bits, and the multiple plastic bits are collected to a plastic bit collector by a dust collecting device.

18. The method of processing waste lead-acid batteries as claimed in claim 14, wherein in the plastic bit recycling step, the multiple low-density fragments are dewatered by a dewatering device and smashed by a smasher to become the multiple plastic bits, and the multiple plastic bits are collected to a plastic bit collector by a dust collecting device.

19. The method of processing waste lead-acid batteries as claimed in claim 15, wherein in the plastic bit recycling step, the multiple low-density fragments are dewatered by a dewatering device and smashed by a smasher to become the multiple plastic bits, and the multiple plastic bits are collected to a plastic bit collector by a dust collecting device.

20. The method of processing waste lead-acid batteries as claimed in claim 16, wherein in the plastic bit recycling step, the multiple low-density fragments are dewatered by a dewatering device and smashed by a smasher to become the multiple plastic bits, and the multiple plastic bits are collected to a plastic bit collector by a dust collecting device.
